(19) United States
(12) Patent Application Publication
(10) Pub. No.: US 2024/0330006 A1
(43) Pub. Date: Oct. 3, 2024

(54) BOOTLOADER STARTUP PROCEDURE MONITORING METHOD AND APPARATUS, EMBEDDED DEVICE, AND STORAGE MEDIUM

(71) Applicant: SHENZHEN TCL NEW TECHNOLOGY CO., LTD., Shenzhen, Guangdong (CN)

(72) Inventors: Zhipeng WEI, Shenzhen, Guangdong (CN); Jiemin ZHU, Shenzhen, Guangdong (CN)

(73) Assignee: SHENZHEN TCL NEW TECHNOLOGY CO., LTD., Shenzhen, Guangdong (CN)

(21) Appl. No.: 18/576,380

(22) PCT Filed: May 24, 2022
(86) PCT No.: PCT/CN2022/094675

§ 371 Date: Jan. 4, 2024

(30) Foreign Application Priority Data
Jul. 7, 2021 (CN) 202110767666.X

(51) Int. Cl. G06F 9/4401; G06F 11/14

(52) U.S. Cl. CPC G06F 9/4403; G06F 11/1417; G06F 2201/86

(57) ABSTRACT

The present disclosure relates to a BootLoader startup procedure monitoring method and apparatus, an embedded device, and a storage medium. The method comprises: acquiring execution process information of target function modules comprised in a BootLoader in a BootLoader startup process; and determining an execution state according to the execution process information when a trigger signal for the BootLoader is detected. The execution process information of a stage corresponding to each target function module in the BootLoader startup process is acquired, effective information is provided for optimization of the startup process, and a fault is effectively positioned when the BootLoader fails to start.

### TECHNICAL FIELD

The present disclosure relates to the field of embedded devices, and more particularly, to a method and apparatus for monitoring a BootLoader startup procedure, an embedded device, and a storage medium.

### BACKGROUND

BootLoader is a bootstrap program executed before running an operating system of an embedded device. A hardware device can be initialized by executing the BootLoader, to establish a mapping table of a memory space, so that an appropriate system software and hardware environment can be established, thereby preparing a processor of the embedded device to finally invoke a kernel of the operating system.

### SUMMARY

### Technical Problems

In general, a startup process of the BootLoader consists of two major stages, each of which in turn includes a plurality of sub-stages. However, there is no effective way in the related art to implement statistics of consumption time of execution of various stages (or sub-stages) of the statistical BootLoader, nor is there an effective way to implement fault location for multiple stages (or sub-stages) involved in the startup process of the BootLoader under the condition of startup failure of a BootLoader.

### Solutions to Problems

### Technical Solutions

In order to solve the above technical problems or at least partially solve the above technical problems, the present disclosure provides a method and apparatus for monitoring a BootLoader startup procedure, an embedded device, and a storage medium.

In a first aspect, the present disclosure provides a method for monitoring a BootLoader startup procedure, including:
obtaining execution process information of a target function module included in a BootLoader in a start process of the BootLoader; and
determining an execution state of the target function module according to the obtained execution process information of the target function module when a trigger signal of the BootLoader is detected.

Optionally, the execution process information includes a start execution time and an end execution time; and
the obtaining of the execution process information of the target function module includes:
upon start of execution of the target function module included in the BootLoader, obtaining a system current time as the start execution time of the target function module; and
upon end of successful execution of the target function module included in the BootLoader, obtaining a system current time as the end execution time of the target function module.

Optionally, the execution process information includes execution consumption time; and
the obtaining of the execution process information of the target function module includes:
upon start of execution of the target function module included in the BootLoader, resetting a system timer to zero and starting the system timer; and
upon end of successful execution of the target function module included in the BootLoader, obtaining a current timing of the system timer as the execution consumption time of the target function module.

Optionally, the trigger signal is configured to indicate end of successful startup of the BootLoader, and the determining the execution state of the target function module according to the obtained execution process information includes:
determining execution consumption time of the target function module according to the obtained execution process information of the target function module;
comparing the execution consumption time with a timeout threshold corresponding to the target function module;
determining that the execution state of the target function module is normal execution when it is determined that a magnitude relationship between the execution consumption time and the timeout threshold meets a first preset condition; and determining that the execution state of the target function module is timeout execution when it is determined that the magnitude relationship between the execution consumption time and the timeout threshold meets a second preset condition.

Optionally, the trigger signal is configured to indicate startup failure of the BootLoader, and the determining of the execution state of the target function module according to the obtained execution process information of the target function module includes:
generating an indication message indicating the startup failure of the BootLoader to transmit the indication message to an external device; and
receiving a data reading request transmitted by the external device based on the indication message to transmit the obtained execution process information of the target function module to the external device to enable the external device to determine the execution state of the target function module according to the received execution process information.

In a second aspect, the present disclosure provides an apparatus for monitoring a BootLoader startup procedure, including:
an information obtaining module for obtaining execution process information of a target function module included in a BootLoader in a startup process of the BootLoader; and
a state determining module for determining an execution state of the target function module according to the obtained execution process information of the target function module when a trigger signal of the BootLoader is detected.

Optionally, the execution process information includes a start execution time and an end execution time; and
the information obtaining module includes:
a first information obtaining sub-module for, upon start of execution of the target function module included in the BootLoader, obtaining a system current time as the start execution time of the target function module; and
a second information obtaining sub-module for, upon end of successful execution of the target function module included in the BootLoader, obtaining a system current time as the end execution time of the target function module.

Optionally, the execution process information includes execution consumption time; and the information obtaining module includes:
a timer starting sub-module for, upon start of execution of the target function module included in the BootLoader, resetting a system timer to zero and starting the system timer; and
a third information obtaining sub-module for, upon end of successful execution of the target function module included in the BootLoader, obtaining a current timing of the system timer as the execution consumption time of the target function module.

In a third aspect, there is provided an embedded device, including a processor, a communication interface, a memory, and a communication bus, where the processor, the communication interface, and the memory perform communication with each other through the communication bus;
the memory is configured to store a computer program; and
the processor is configured to implement, when a program stored on the memory is executed by the processor, steps of the method for monitoring the BootLoader startup procedure described in any one of the embodiments of the first aspect.

In a fourth aspect, there is provided a computer readable storage medium having stored thereon a computer program which, when executed by a processor, implements steps of the method for monitoring the BootLoader startup procedure described in any one of the embodiments of the first aspect.

### BENEFICIAL EFFECTS OF INVENTION

### Beneficial Effects

The above technical solutions provided by the embodiments of the present disclosure have the following advantages compared with the related art.

According to the methods provided in the embodiments of the present disclosure, the execution process information of the target function module included in the BootLoader is obtained in the startup process of the BootLoader, and when the trigger signal of the BootLoader is detected, the execution state of the target function module is determined according to the obtained execution process information of the target function module, so as to obtain the execution process information of each target function module (i.e., each stage) included in the BootLoader in the startup process of the BootLoader, which can optimize the BootLoader startup procedure with the granularity of each stage included in the BootLoader startup procedure, thereby providing effective information for improving a startup speed of the embedded device. Further, even if the startup of the BootLoader fails, a stage in which an abnormality occurs in the startup process of the BootLoader can be determined according to the obtained execution process information, thereby providing effective information for fault location.

### BRIEF DESCRIPTION OF THE DRAWINGS

### Description of the Drawings

The accompanying drawings, which are incorporated in and constitute a part of this specification, illustrate embodiments consistent with the present disclosure and, together with the description, serve to explain the principles of the present disclosure.

In order to more clearly illustrate the technical solutions in embodiments of the present disclosure or related art, the accompanying drawings depicted in the description of the embodiments or the related art will be briefly described below. It will be apparent that other drawings may be obtained from these drawings without creative effort by those skilled in the art.

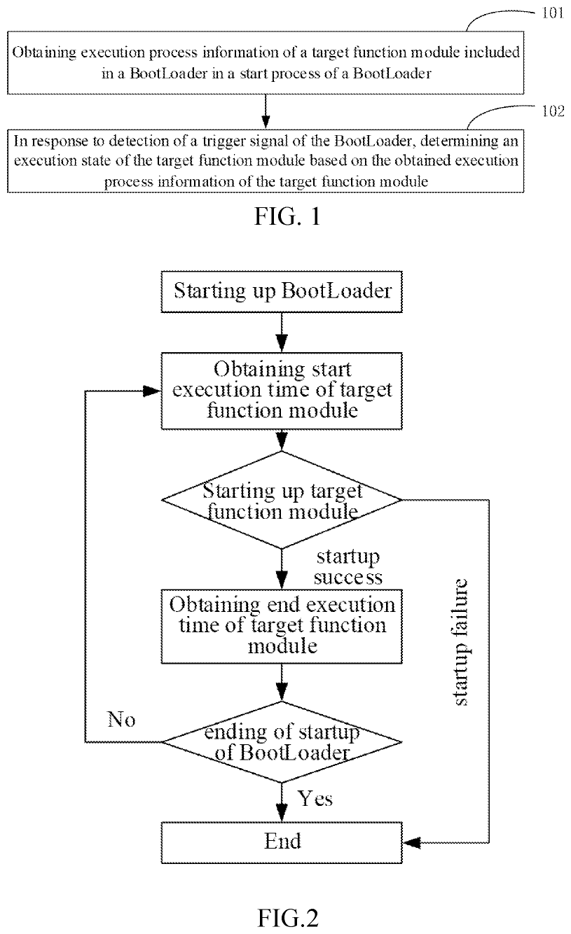

FIG. 1 is a flow diagram of a method for monitoring a BootLoader startup procedure according to some embodiments of the present disclosure.

FIG. 2 is a flow diagram of another method for monitoring a BootLoader startup procedure according to some embodiments of the present disclosure.

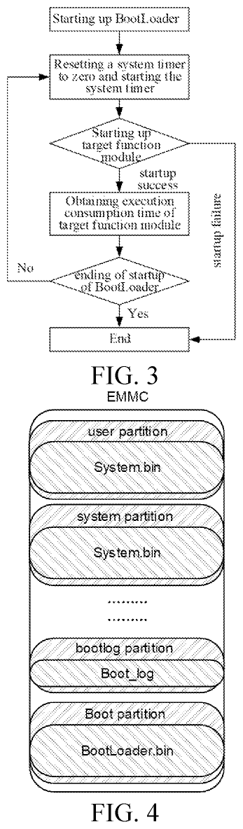

FIG. 3 is a flow diagram of yet other method for monitoring a BootLoader startup procedure according to some embodiments of the present disclosure.

FIG. 4 is a schematic diagram of newly adding a partition in an Embedded MultiMedia Card (EMMC) according to some embodiments of the present disclosure.

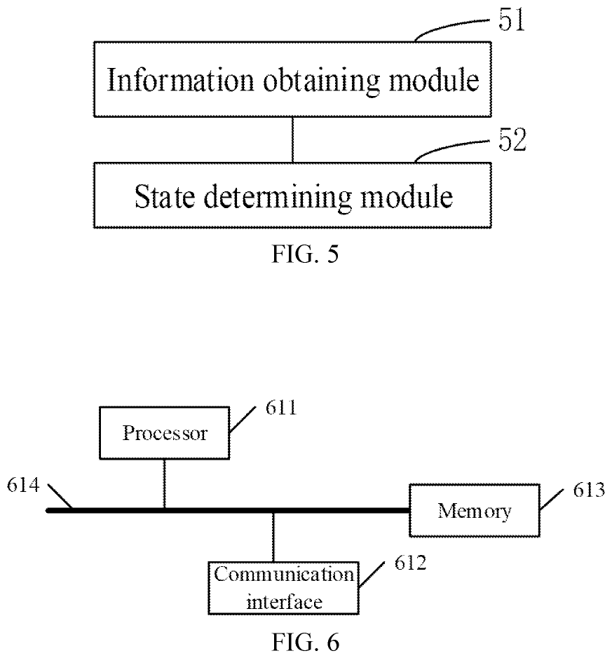

FIG. 5 is a flow diagram of an apparatus for monitoring a BootLoader startup procedure according to some embodiments of the present disclosure.

FIG. 6 is a schematic structural diagram of an embedded device according to some embodiments of the present disclosure.

### EMBODIMENTS OF INVENTION

### Detailed Description

In order to make objects, technical solutions, and advantages of embodiments of the present disclosure clearer, technical solutions in embodiments of the present disclosure will be clearly and completely described below in conjunction with drawings in the embodiments of the present disclosure. Obviously, the described embodiments are a part of embodiments of the present disclosure, rather than all the embodiments. Based on the embodiments in the present disclosure, all other embodiments obtained by those skilled in the art without creative work fall within the protection scope of the present disclosure.

FIG. 1 is a flow diagram of a method for monitoring a BootLoader startup procedure according to some embodiments of the present disclosure. As an embodiment, the method may be applied to an embedded device, such as a smart television. As shown in FIG. 1, the method includes following steps 101-S102.

At step 101, execution process information of a target function module included in a BootLoader may be obtained in a startup process of the BootLoader.

Generally, the startup process of the BootLoader includes two stages, i.e., a first stage and a second stage. The first stage generally includes following sub-stages: initialization of a hardware device, preparation of a RAM space for loading a second stage of the BootLoader, copying of the second stage of the BootLoader to the RAM space, setting of a stack, and jumping to an entry point of the second stage. The second stage generally includes following sub-stages: initialization of a hardware device to be used in the second stage, detection of a system memory map, reading of a kernel image and a root file system image from an Flash to the RAM space, setting of a startup parameter for the kernel, and calling of the kernel. Further, each of the sub-stages may be divided into a plurality of sub-unit stages. For example, the initialization of the hardware device includes initialization of a controller, initialization of a register, and the like. Thus, the startup process of the BootLoader includes a plurality of stages, each of which may include a plurality of sub-stages, and each of the sub-stages may in turn include a plurality of sub-unit stages.

In an application of the startup process of the BootLoader, each of the sub-unit stages in the startup process of the BootLoader can be encapsulated as a function module. As such, the BootLoader includes a plurality of function modules, and the startup procedure of the BootLoader refers to a process in which each of the function modules starts up in sequence.

Further, in the embodiment of the present disclosure, one or more target function modules may be determined from a plurality of function modules included in the BootLoader, and the execution process information of each of the one or more target function modules may be obtained in the startup process of the BootLoader. Alternatively, each of the function modules or a portion of the function modules included in the BootLoader may be set as the target function module in advance by the user. In addition, the user can dynamically set the target function module according to actual service requirements, which means that the target function module is variable and can be set according to user requirements. In the same BootLoader, the target function module may be different during different times of startup of the BootLoader, which is not limited in the embodiment of the present disclosure.

As an alternative embodiment, the execution process information of the target function module may include a start execution time and an end execution time of the target function module. How to implement the obtaining of the start execution time and the end execution time of the target function module included in the BootLoader in the startup process of the BootLoader is described below in embodiments shown in FIG. 2 and is not described in details herein.

As another alternative embodiment, the execution process information of the target function module may include execution consumption time of the target function module. How to implement the obtaining of the execution consumption time of the target function module included in the BootLoader in the startup process of the BootLoader is described below in embodiments shown in FIG. 3 and is not described in details herein.

In embodiments of the present disclosure, after the execution process information of the target function module included in the BootLoader is obtained, the obtained execution process information may be written into a designated storage medium. Alternatively, the designated storage medium may be a partition in an EMMC of an embedded device. For example, as shown in FIG. 4, which is a schematic diagram of newly adding a partition in an EMMC according to some embodiments of the present disclosure. The EMMC may include partitions such as a user partition, a system partition, and a boot partition. In particular, in the embodiments of the present disclosure, a partition is newly added to the EMMC to start a bootlog partition, which is dedicated to storing execution process information of a target function module included in the BootLoader. It can be understood that the EMMC has the advantages of large capacity, high read/write speed, good compatibility, and the like. Therefore, the obtained execution process information is written into the EMMC of the embedded device, the stability of storing the execution process information can be improved, and the speed at which the execution process information is subsequently obtained from the EMMC can be improved.

At step 102, an execution state of the target function module may be determined according to the obtained execution process information of the target function module when a trigger signal of the BootLoader is detected.

As an alternative embodiment, the trigger signal may be used to indicate successful startup of the BootLoader. When the BootLoader is successfully started up, the system can be normally started up. Based on this, in the step 102, when it is detected that the BootLoader is successfully started up, the execution process information of each of the target function modules stored in the designated storage medium can be obtained, and further, the execution state of each of the target function modules can be determined according to the execution process information of the target function module. Specifically, the execution process information can be obtained by an application program installed in an embedded device.

Specifically, if the execution process information includes the start execution time and the end execution time of the target function module, the execution time of the target function module is determined by the following equation (1) for each of the target function modules.

$$T = t 1 - t 2 \qquad equation ( 1 )$$

Where T represents execution consumption time, t1 represents an end execution time, and t2 represents a start execution time.

Then, for each of the target function modules, the execution consumption time of the target function module is compared with a timeout threshold corresponding to the target function module. When it is determined that a magnitude relationship between the execution consumption time and the timeout threshold meets a first preset condition, for example, when the execution consumption time is less than or equal to the timeout threshold, it means that the execution consumption time of the target function module is within an expected range, so that it can be determined that the execution state of the target function module is normal execution. On the contrary, when it is determined that the magnitude relationship between the execution consumption time and the timeout threshold satisfies a second preset condition, for example, when the execution consumption time is greater than the timeout threshold, it means that the execution consumption time of the target function module exceeds the expected range, and therefore it can be determined that the execution state of the function module is timeout execution. It should be noted that in an application, different timeout thresholds may be set for different target function modules according to actual conditions.

For each of the target function modules, if the execution process information includes execution consumption time of the target function module, then the execution state of the target function module may be determined by comparing the execution consumption time of the target function module with a timeout threshold corresponding to the target function module.

In addition, in an application, the embedded device may further transmit the obtained execution process information of each of the target function modules included in the BootLoader to an external device, such as a cloud platform corresponding to an application program, through the application program, and the external device determines the execution state of each of the target function modules according to the received execution process information of the target function module included in the BootLoader.

As another alternative embodiment, the trigger signal is used to indicate startup failure of the BootLoader. Under the conditions of startup failure of the BootLoader, the system cannot be started up normally. In this case, the execution state information of each of the target function modules stored in the designated storage medium cannot be obtained by the application program installed in the embedded device according to the description in the above embodiments. In this case, the execution process information stored in the designated storage medium can be obtained by means of an external diagnostic tool. It should be noted that, since startup of the BootLoader fails, the execution process information of a portion of the target function modules possibly contained in the BootLoader is stored in the designated storage medium.

Specifically, in step 102, when the startup failure of the BootLoader is detected, an indication message indicating the startup failure of the BootLoader is generated and transmitted to the external device.

As an alternative implementation, after receiving the indication message, the external device may automatically call the diagnostic tool to transmit a data reading request to the embedded device. As another alternative implementation, after receiving the indication message, the external device may transmit a reminder message to the user to notify the user of the startup failure of the BootLoader, and then the user manually controls the external device to call the diagnostic tool to transmit the data reading request to the embedded device. Alternatively, the form of the reminder message includes, but is not limited to, an audio signal, an optical signal, a short message of a mobile phone, an email, and the like.

After receiving the data reading request, the embedded device transmits the execution process information stored in the designated storage medium to the external device, so that the external device determines the execution state of each of the target function modules included in the BootLoader according to the received execution process information.

As an alternative implementation, the external device may first determine whether the execution state of each of the target function modules is an execution success or an execution error according to the received execution process information, where if the external device receives the execution process information of a certain target function module, it may be determined that the execution state of the target function module is the execution success. On the contrary, if the external device does not receive the execution process information of a certain target function module, it may be determined that the execution state of the target function module is the execution error.

Further, for a target function module of which the execution state is the execution success, the external device may determine, according to the received execution process information of the target function module, whether the execution state of the target function module is timeout execution. Specifically, how to determine, according to the received execution process information of the target function module, whether the execution state of the target function module is timeout execution can refer to the above related description, which is not repeatedly described herein.

According to the technical solutions provided in the embodiments of the present disclosure, the execution process information of the target function module included in the BootLoader is obtained in the startup process of the BootLoader, and when the trigger signal of the BootLoader is detected, the execution state of the target function module is determined according to the obtained execution process information of the target function module, so as to obtain the execution process information of each target function module (i.e., each stage) included in the BootLoader in the startup process of the BootLoader, which can optimize the BootLoader startup procedure with the granularity of each stage included in the BootLoader startup procedure, thereby providing effective information for improving a startup speed of the embedded device. Further, even if the startup of the BootLoader fails, a stage in which an abnormality occurs in the startup process of the BootLoader can be determined according to the obtained execution process information, thereby providing effective information for fault location.

As can be seen from the above description, as one embodiment, the execution process information may include a start execution time and an end execution time. A specific implementation of the present embodiment is described below.

In the present embodiment, a first customization code may be inserted in advance at a start position of a code line of each of the target function modules and used to indicate obtaining of a system current time and writing the obtained system current time into the designated storage medium as the start execution time of the target function module, and a second customization code may be inserted in advance at a end position of the code line of each of the target function modules and used to indicate obtaining of the system current time and writing the obtained system current time into the designated storage medium as the end execution time of the target function module.

Based on this, as shown in FIG. 2, in the above-mentioned step 101, in the startup process of each of the target function modules included in the BootLoader, the first customization code inserted at the start position of the code line of the target function module is first executed so as to obtain the system current time, and the obtained system current time is written into the designated storage medium as the start execution time of the target function module.

It should be understood that, after completing the execution of the first customization code normally, an original function code in the target function module will continue to be executed until the original function code is executed, and the second customization code inserted at the end position of the code line in the target function module is executed, to obtain the system current time and write the obtained system current time into the designated storage media as the end execution time of the target function module.

Further, as shown in FIG. 2, if a certain target function module cannot be started up normally, the BootLoader startup procedure is ended, and startup of the BootLoader fails. In this case, the second customization code inserted into the end position of the code line of the target function module is not executed, so that the end execution time of the target function module cannot be written into the designated storage medium.

In the embodiment of the present disclosure, if the end execution time of the target function module cannot be written into the designated storage medium, it means that the execution process information of the target function module cannot be obtained.

Obtaining of the start execution time and the end execution time of each stage in the startup process of the BootLoader can be implemented in the embodiments shown in FIG. 2, which can provide effective information for optimizing the startup process of the BootLoader and optimizing the startup speed of the embedded device.

As can be seen from the above description, as another embodiment, the execution process information may include execution consumption time. A specific implementation of the present embodiment is described below.

In the present embodiment, a third customization code may be inserted in advance at a start position of a code line of each of the target function modules and used to indicate that the timer is reset to zero and started, and a fourth customization code may be inserted in advance at an end position of the code line of each of the target function modules and used to indicate that the current timing of the timer is obtained and the obtained current timing is written into the designated storage medium as execution consumption time of the target function module.

Based on this, in step 101, as shown in FIG. 3, in the startup process of each of the target function modules included in the BootLoader, the third customization code inserted at the start position of the code line of the target function module is first executed, so as to implement the resetting of the timer and start of the timer.

It should be understood that, after completing the execution of the third customization code normally, an original function code in the target function module will continue to be executed until the original function code is executed, and the fourth customization code inserted into the end position of the code line in the target function module is executed, to obtain a current timing of the timer and write the obtained current timing into the designated storage media as the end execution time of the target function module.

Further, as shown in FIG. 3, if a certain target function module cannot be started normally, the BootLoader startup procedure is ended, and startup of the BootLoader fails. In this case, the fourth customization code inserted at the end position of the code line of the target function module cannot be executed, so that the execution consumption time of the target function module cannot be written into the designated storage medium.

obtaining of the execution consumption time of each stage in the startup process of the BootLoader can be implemented through the procedure shown in FIG. 3, which can provide effective information for optimizing the startup process of the BootLoader and optimizing the startup speed of the embedded device.

FIG. 5 is a flow diagram of an apparatus for monitoring a BootLoader startup procedure according to some embodiments of the present disclosure. As shown in FIG. 5, the apparatus includes an information obtaining module 51 and a state determining module 52.

The information obtaining module 51 is configured for obtaining execution process information of a target function module included in a BootLoader in the BootLoader startup procedure.

The state determining module 52 is configured for determining an execution state of the target function module according to the obtained execution process information of the target function module when a trigger signal of the BootLoader is detected.

Optionally, the execution process information includes a start execution time and an end execution time; and the information obtaining module 51 includes (not shown):
a first information obtaining sub-module for, upon start of execution of the target
function module included in the BootLoader, obtaining a system current time as the start execution time of the target function module; and
a second information obtaining sub-module for, upon end of successful execution of the target function module included in the BootLoader, obtaining a system current time as the end execution time of the target function module.

Optionally, the execution process information includes execution consumption time; and the information obtaining module 51 includes (not shown):
a timer starting sub-module for, upon start of execution of the target function module included in the BootLoader, resetting a system timer to zero and starting the system timer; and
a third information obtaining sub-module for, upon end of successful execution of the target function module included in the BootLoader, obtaining a current timing of the system timer as the execution consumption time of the target function module.

Optionally, the state determining module 52 includes (not shown):
a consumption time determining sub-module for determining execution consumption time of the target function module according to the obtained execution process information when the trigger information is configured to indicate end of successful startup of the BootLoader;
a first comparing sub-module for comparing the execution consumption time with a timeout threshold corresponding to the target function module; and
a first determining sub-module for determining that the execution state of the target function module is normal execution when it is determined that a magnitude relationship between the execution consumption time and the timeout threshold meets a first preset condition; and determining that the execution state of the target function module is timeout execution when it is determined that the magnitude relationship between the execution consumption time and the timeout threshold meets a second preset condition.

Optionally, the state determining module 52 includes (not shown):
a message generating sub-module for generating an indication message for indicating startup failure of the BootLoader when the trigger signal is configured to indicate the startup failure of the BootLoader;
a message transmitting sub-module for transmitting the indication message to an external device;
a request receiving sub-module for receiving a data reading request transmitted by the external device based on the indication message; and
an information transmitting sub-module for transmitting the obtained execution process information of the target function module to the external device to enable the external device to determine an execution state of the target function module according to the received execution process information.

As shown in FIG. 6, another embodiment of the present disclosure provides an embedded device, including a processor 611, a communication interface 612, a memory 613, and a communication bus 614. The processor 611, the communication interface 612, and the memory 613 perform communication with each other through the communication bus 614.

The memory 613 is used to store a computer program.

In an embodiment of the present disclosure, the processor 611 is configured to implement, when a program stored on the memory 613 is executed by the processor 611, the method for monitoring the BootLoader startup procedure described in any one of the above embodiments, where the method includes:
obtaining execution process information of a target function module included in a BootLoader in a start process of the BootLoader; and
in response to detection of a trigger signal of the BootLoader, determining an execution state of the target function module based on the obtained execution process information of the target function module.

Yet another embodiment of the present disclosure further provides a computer readable storage medium having stored a computer program thereon which, when executed by a processor, implements the method for monitoring the BootLoader startup procedure described in any one of the above embodiments.

It should be noted that the terms “first” or “second” and the like, as used herein, are used herein only to distinguish one entity or operation from another entity or operation, without necessarily requiring or implying any such actual relationship or order between such entities or operations. The terms “comprises,” “comprising,” or any other variation thereof, are intended to cover a non-exclusive inclusion, such that a process, method, article, or apparatus that comprises a list of elements includes not only those elements but also other elements not expressly listed, or also includes elements inherent to such process, method, article, or apparatus. Without more limitations, an element defined by a statement “include at least one of” does not rule out additional identical elements included in a process, method, article, or apparatus that includes the element.

The foregoing description is merely illustrative of specific embodiments of the present disclosure, enabling those skilled in the art to understand or practice the present disclosure. Various modifications to these embodiments will be apparent to those skilled in the art, and the generic principles defined herein may be practiced in other embodiments without departing from the spirit or scope of the present disclosure. Accordingly, the present disclosure is not to be limited to the embodiments shown herein, but is to be accorded the widest scope consistent with the principles and novel features claimed herein.

1. A method for monitoring a BootLoader startup procedure, comprising:
obtaining execution process information of a target function module included in a BootLoader in a start process of a BootLoader; and
in response to detection of a trigger signal of the BootLoader, determining an execution state of the target function module based on the obtained execution process information of the target function module.

2. The method of claim 1, wherein the execution process information comprises a start execution time and an end execution time; and
the obtaining of the execution process information of the target function module comprises:
upon start of execution of the target function module included in the BootLoader, obtaining a system current time as the start execution time of the target function module; and
upon end of successful execution of the target function module included in the BootLoader, obtaining a system current time as the end execution time of the target function module.

3. The method of claim 1, wherein the execution process information comprises execution consumption time; and
the obtaining of the execution process information of the target function module comprises:
upon start of execution of the target function module included in the BootLoader, resetting a system timer to zero and starting the system timer; and
upon end of successful execution of the target function module included in the BootLoader, obtaining a current timing of the system timer as the execution consumption time of the target function module.

4. The method of claim 1, wherein the trigger signal is configured to indicate end of successful startup of the BootLoader, and the determining the execution state of the target function module based on the obtained execution process information comprises:
determining execution consumption time of the target function module based on the obtained execution process information of the target function module;
comparing the execution consumption time with a timeout threshold corresponding to the target function module;
in response to determining that a magnitude relationship between the execution consumption time and the timeout threshold meets a first preset condition, determining that the execution state of the target function module is normal execution; and
in response to determining that the magnitude relationship between the execution consumption time and the timeout threshold meets a second preset condition, determining that the execution state of the target function module is timeout execution.

5. The method of claim 1, wherein the trigger signal is configured to indicate startup failure of the BootLoader, and the determining the execution state of the target function module based on the obtained execution process information comprises:
generating an indication message indicating the startup failure of the BootLoader to transmit the indication message to an external device; and
receiving a data reading request transmitted by the external device based on the indication message to transmit the obtained execution process information of the target function module to the external device to enable the external device to determine the execution state of the target function module based on the received execution process information.

6. The method of claim 1, wherein the target function module is one or more of a plurality of function modules included in the BootLoader, a startup process of the BootLoader includes a plurality of stages, each of the stages includes a plurality of sub-stages, each of the sub-stages includes a plurality of sub-unit stages, and each of the sub-unit stages is encapsulated as one of the function modules.

7. The method of claim 6, wherein the startup process of the BootLoader refers to a process in which each of the function modules is started up in sequence.

8. The method of claim 1, further comprising: after the obtaining of the execution process information of the target function module included in the BootLoader,
writing the obtained execution process information into an embedded multimedia memory of an embedded device to read the obtained execution process information of the target function module from the embedded multimedia memory in use.

9. The method of claim 5, wherein the external device first determines whether an execution status of each of the target function modules is an execution success or an execution error based on the received execution process information.

10. The method of claim 9, wherein in response to the external device receiving the execution process information of a target function module, it is determined that the execution state of the target function module receiving the execution process information is the execution success.

11. The method of claim 10, wherein, for the target function module of which the execution state is the execution success, the external device determines whether the execution state of the target function module is timeout execution based on the received execution process information of the target function module.

12. The method of claim 9, wherein in response to the external device not receiving the execution process information of a target function module, it is determined that the execution state of the target function module receiving the execution process information is the execution error.

13. The method of claim 2, wherein the execution process information comprises execution consumption time; and
the method further comprises: calculating a difference between the end execution time and the start execution time to obtain the execution consumption time.

14-18. (canceled)

19. An embedded device, comprising a processor, a communication interface, a memory, and a communication bus, wherein the processor, the communication interface, and the memory perform communication with each other through the communication bus;
the memory is configured to store a computer program; and
the processor is configured to implement, when a program stored on the memory is executed by the processor, a method for monitoring a BootLoader startup procedure, comprising:
obtaining execution process information of a target function module included in a BootLoader in a start process of a BootLoader; and
in response to detection of a trigger signal of the BootLoader, determining an execution state of the target function module based on the obtained execution process information of the target function module.

20. A non-transistory computer readable storage medium having stored thereon a computer program which, when executed by a processor, implements a method for monitoring a BootLoader startup procedure, comprising:
obtaining execution process information of a target function module included in a BootLoader in a start process of a BootLoader; and
in response to detection of a trigger signal of the BootLoader, determining an execution state of the target function module based on the obtained execution process information of the target function module.

21. The embedded device of claim 19, wherein the execution process information comprises a start execution time and an end execution time; and
the obtaining of the execution process information of the target function module comprises:
upon start of execution of the target function module included in the BootLoader, obtaining a system current time as the start execution time of the target function module; and
upon end of successful execution of the target function module included in the BootLoader, obtaining a system current time as the end execution time of the target function module.

22. The embedded device of claim 19, wherein the execution process information comprises execution consumption time; and
the obtaining of the execution process information of the target function module comprises:
upon start of execution of the target function module included in the BootLoader, resetting a system timer to zero and starting the system timer; and
upon end of successful execution of the target function module included in the BootLoader, obtaining a current timing of the system timer as the execution consumption time of the target function module.

23. The embedded device of claim 19, wherein the trigger signal is configured to indicate end of successful startup of the BootLoader, and the determining the execution state of the target function module based on the obtained execution process information comprises:
determining execution consumption time of the target function module based on the obtained execution process information of the target function module;
comparing the execution consumption time with a timeout threshold corresponding to the target function module;
in response to determining that a magnitude relationship between the execution consumption time and the timeout threshold meets a first preset condition, determining that the execution state of the target function module is normal execution; and
in response to determining that the magnitude relationship between the execution consumption time and the timeout threshold meets a second preset condition, determining that the execution state of the target function module is timeout execution.

24. The embedded device of claim 19, wherein the trigger signal is configured to indicate startup failure of the BootLoader, and the determining the execution state of the target function module based on the obtained execution process information comprises:
generating an indication message indicating the startup failure of the BootLoader to transmit the indication message to an external device; and
receiving a data reading request transmitted by the external device based on the indication message to transmit the obtained execution process information of the target function module to the external device to enable the external device to determine the execution state of the target function module based on the received execution process information.

25. The embedded device of claim 19, wherein the method further comprises: after the obtaining of the execution process information of the target function module included in the BootLoader,
writing the obtained execution process information into an embedded multimedia memory of an embedded device to read the obtained execution process information of the target function module from the embedded multimedia memory in use.
